(19) United States
(12) Patent Application Publication
(10) Pub. No.: US 2006/0285528 A1
(43) Pub. Date: Dec. 21, 2006

(54) Method and apparatus for power saving in beacon generation of wireless networks in ad hoc mode

(76) Inventors: Xia Gao, Cupertino, CA (US); Fujio Watanabe, Union City, CA (US); Moo Ryong Jeong, Saratoga, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/454,265

(22) Filed: Jun. 16, 2006

Related U.S. Application Data
(60) Provisional application No. 60/692,768, filed on Jun. 21, 2005.

(51) Int. Cl. H04Q 7/24

(52) U.S. Cl. 370/338

(57) ABSTRACT

Methods are disclosed to support power saving states of a beacon station in an ad hoc wireless local area network (WLAN). Some of the methods allow exchanging power management information among stations in the wireless network and to allow beacon station handovers. In some methods, always-on stations are given a higher priority to become a beacon station or a beacon station handover destination. The methods achieve good power saving while minimizing beacon handover frequency.

### CROSS REFERENCE TO RELATED APPLICATIONS

The present application claims priority of U.S. provisional patent application No. 60/692,768, filed Jun. 21, 2005, incorporated herein by reference.

### BACKGROUND OF THE INVENTION

1. Field of the Invention

The present invention relates to wireless computer networks; in particular, the present invention relates to power saving operations in an ad hoc wireless computer network.

2. Discussion of the Related Art

A wireless network allows a mobile user to maintain network access despite the mobile user's changes in location continuously or from time to time. By necessity, a mobile device operates from battery power and battery power is a scarce resource. Recently, improvements in battery lifetime for a mobile device have not kept up with improvements in computing power and communication capability. Hence, power efficiency is an important design parameter for a wireless computer network.

As compared to power management in an infrastructure network, power management in the link layer of an ad hoc wireless network (e.g., an ad hoc wireless network using the independent basic service set or “IBSS” under 802.11b) is not well understood and is not efficient. For example, in a wireless local area network (WLAN), the access point (“AP”) has global knowledge of the power-saving states of all stations (“STAs”) associated with it. In such a network, all communication with the mobile nodes go through the AP, so that the AP may buffer data packets designating STAs in a power-saving (“PS”) mode. During pre-specified time intervals, the AP notifies these STAs to retrieve the buffered packets. In contrast, however, in an ad hoc wireless network, there is no entity in IBSS similar to AP that has global knowledge of power-saving states of all nodes. Instead, each STA stores packets locally and communicates individually with its peers to schedule packet delivery.

Due to the distributed nature of IBSS, many power-saving issues exist in IBSS under 802.11.

In WLANs operating under 802.11, the distributed coordination function (“DCF”) uses a Carrier Sense Multiple Access with Collision Avoidance (CSMA/CA) protocol to determine—in a distributed manner—when a station operating within the wireless network is permitted to transmit and receive frames. Under CSMA/CA, prior to transmission, an STA senses the medium to determine if it is “busy” (i.e., if another STA is transmitting). If the medium is not busy, the STA may transmit. CSMA/CA requires a minimum specified separation in time, called the “interframe space” (IFS), between contiguous frame sequences. The transmitter waits the medium to become idle for at least IFS before transmitting. The value of IFS varies according to the priority of the transmitted frames. Examples of IFS values include: short IFS (SIFS), point IFS (PIFS) and distributed IFS (DIFS).

SIFS is the shortest interframe space and is used when a group of STAs have seized the medium for the duration of the frame exchange sequence to be performed. SIFS ensures completion of the frame exchange sequence before other STAs can access the medium, as the other STAs are required to wait for the medium to become idle for a time period longer than SIFS before attempting to transmit into the medium. Acknowledgment (ACK) frames, for example, use SIFS.

PIFS is used by STAs operating under the point coordination function (PCF) to gain priority access to the medium at the start of a contention-free period. PIFS is longer than SIFS, but shorter than DIFS.

DIFS is used by stations operating under the DCF to transmit data frames and management frames (e.g., probe request and probe responses).

Under DCF, if the medium is found busy, an STA defers transmission until after the current transmission completes. After a deferral, or prior to attempting to transmit again immediately after a successful transmission, a station selects a random “back-off” interval during which it does not transmit. A back-off interval counter keeps track of the interval.

Some example formats of control packets are provided in FIGS. 1 (“probe request frame”), 3 (“probe response frame”), and 4 (“acknowledge (ACK) frame”). A control packet has a format (i.e., “management frame”) generically shown in FIG. 5. As shown in FIG. 5, the format includes a medium access control (MAC) header, a frame body and a frame check sequence (FCS). The FCS allows a determination on the integrity of a transmitted frame. In a 802.11 WLAN, an STA uses the destination address (DA) field in the MAC header of a packet to make receive decisions regarding the packet. For example, the DA field may contain a group address (e.g., a broadcast address) and, if the frame is not a beacon frame, the basic service set identifier (BSSID) must be validated (i.e., the BSSID field of the frame is the same BSSID of the recipient). (The BSSID field can be a broadcast BSSID in a probe request frame.) As another example, an STA, including an access point, may respond with an ACK frame within an SIFS deferral upon receiving a data frame or a management frame that does not specify a group address in the DA field. An ACK frames is not be transmitted for a packet specifying a group address in the DA field.

The state of the medium is determined from the physical and virtual carrier-sense functions. The physical layer provides a physical carrier-sense mechanism based on energy detection in the wireless medium. The MAC layer provides a virtual carrier-sense mechanism, referred to as the network allocation vector (NAV). The NAV predicts future traffic in the medium based on duration information that is announced in the frames prior to the actual exchange of data. With a few exceptions, such duration information is found in the MAC header.

A probe request frame is sent by an STA scanning an area for an existing network. A probe request frame invites the APs in the area to respond with probe response frames. As shown in FIG. 1, a probe request frame includes a service set identifier (SSID) field and the data rates supported by the STA. An AP receiving a probe request frame determines whether to invite the STA to join the network. As shown in FIG. 2, type bits (B2, B3) and subtype bits (B4-B7) of the frame control field identify both the frame type (e.g., “management”) and the subtype (e.g., “probe request”). Table 1 shows the various possible values of the type and subtype bits.

TABLE 1
Example of valid type and subtype combinations

| | | Subtype | |
|---|---|---|---|
| Type Value | Type | value | |
| B3 B2 | description | B7 B6 B5 B4 | Subtype description |
| 00 | Management | 0100 | Probe request |
| 00 | Management | 0101 | Probe response |
| 00 | Management | 1000 | Beacon |
| 00 | Management | 1001 | ATIM |
| 00 | Management | 1101 | Action |
| 00 | Management | 1110-1111 | Reserved |
| 01 | Control | 1101 | Acknowledgement (ACK) |

To respond to a probe request frame, an AP sends a probe response frame (FIG. 3) to the scanning STA to inform the availability and the characteristics of the networks. Other frames include, for example, an ACK frame which acknowledges a received data frame, or a beacon frame (which announces the existence of a network).

Sending out beacon frames is an important part of many network maintenance tasks. Beacon frames are typically transmitted at regular intervals to allow mobile STAs to find, identify and match parameters of a network they may join. In a beacon frame, the frame body includes the following fields: (a) timestamp, (b) beacon interval, (c) capability, (d) SSID, (e) IBSS parameter set, and (f) traffic indication map (TIM). The information field within the IBSS parameter field contains an ATIM Window parameter.

In an infrastructure network, APs are responsible for transmitting Beacon frames. The service area of an AP is defined by the reach of its beacon frames. Timing for the BSS is determined by the beacon interval specified in a beacon frame. The time interval between successive transmissions of beacon frames is called the “target beacon transition time” or TBTT.

In an IBSS network, beacon frames are generated in a distributed manner. The beacon interval is included in both beacon frames and probe response frames. The STAs adopt the beacon interval at the time each STAjoin the ad hoc network. In an IBSS network, all members participate in beacon generation. Each STA maintains a timing synchronization finction (TSF) timer for beacon interval timing. As an IBSS network does not have access points, when an STA has buffered frames for a receiver that is in a low-power mode, the STA sends an announcement traffic indication message (ATIM) frame during the ATIM window to notify the recipient that it has buffered data for the recipient. The ATIM frame has a null frame body.

FIG. 7 shows the process of beacon frame generation in an IBSS. At each TBTT, each station (a) waits for the packet currently transmitting in the channel to complete, (b) suspends the back-off timer for any pending non-beacon or non-ATIM transmission, and (c) calculates a random delay that is uniformly distributed in the range between zero and 2*CWₘᵢₙ*TU, where CWmin is the size of the minimum contention window and TU is the timing unit. The STA then sets a timer using this random delay and wait for this timer to expire. If a beacon frame arrives before the random delay timer expires, the wait is canceled, and the backoff timer is resumed. However, if the random delay timer expires without the STA receiving a beacon frame, the STA sends out a beacon frame. ATIM messages are transmitted following the beacon frame from source stations to destination stations using the same distributed coordination function (DCF) algorithm as ordinary data packets. The length of the ATIM window is fixed and always starts from the theoretical TBTT time, whether or not there is packet transmission during the beacon interval.

The timestamp field in the beacon frame represents the value in the TSF timer at the frame's source. A station joining an IBSS network initializes its TSF timer to 0 and refrains from transmitting a beacon frame or a probe response frame until after it receives a beacon frame or a probe response frame from another member of the IBSS with a matching SSID to ensure proper synchronization within the IBSS network.

In an IBSS network, an STA may be in an “awake” state, in which the STA is fully powered, or in a “doze” state, in which the STA consumes little power and is unable to transmit or receive. The term “power management” for an STA refers to the manner in which an STA transits between awake and doze states.

In an infrastructure network, an STA changing its power management mode to a doze or PS state informs the AP using the power management bits within the frame control field of the transmitted frames. Thereafter, the AP does not arbitrarily transmit MAC service data units (MSDUs) to the STA. The MSDUs are buffered and transmitted at designated times. The STAs associated with an AP that has buffered MSDUs for the STAs are identified in a TIM that is included in all beacon frames generated by the AP. By interpreting the TIM, an STA is made aware that an MSDU is buffered for it. An STA operating in PS modes periodically listens for beacon frames, according to its listen interval and receive delivery traffic indication message (DTIM) parameters. Upon learning that an MSDU is currently buffered in the AP, the STA transmits a short PS-poll frame to the AP, which responds with the corresponding buffered MSDU immediately, or acknowledges the PS-Poll and responds with the corresponding MSDU at a later time. If an STA in its BSS is in PS mode, the AP buffers all broadcast and multicast MSDUs and delivers them to the STA immediately following the next beacon frame containing a DTIM transmission.

FIG. 8 shows the basic operations of power management in an IBSS. As shown in FIG. 8, after each TBTT, an ATIM window is defined. During the ATIM window, STAs operating in PS mode are awake to listen to beacon frames or ATIM frames. To transmit an MSDU to a recipient STA in a PS mode, the transmitting STA first transmits an ATIM frame during the ATIM window. ATIM transmissions from different STAs are randomized using the common DCF backoffprocedure. Directed ATIMs are acknowledged. If a ACK frame is not received in response to a directed ATIM, the transmitting STA executes the back-off procedure to attempt a retransmission. Multicast ATIMs are not acknowledged. After the ATIM interval, the acknowledged MSDUs and the announced broadcast/multicast MSDUs are transmitted to STAs in the PS mode, using normal DCF access procedures. If an STA is unable to transmit a buffered MSDU during the beacon interval in which the MSDU is announced, the STA retains the buffered MSDU and announces it again in an ATIM during the next ATIM window. After all buffered MSDUs are transmitted, MSDUs are transmitted unannounced to STAs that are in the awake state.

An STA operating in PS mode enters the awake state prior to each TBTT. If the STA receives an ATIM management frame directed to it, or a multicast ATIM management frame during the ATIM Window, the STA remains in the awake state until the end of the next ATIM window. An STA that has transmitted a beacon frame or an ATIM management frame will remain in the awake state until the end of the next ATIM window, regardless of whether or not an acknowledgement is received for the ATIM. If the STA has not transmitted an ATIM and does not receive either an ATIM management frame directed to it, or a multicast ATIM management frame during the ATIM window, the STA may return to the Doze state following the end of the current ATIM window.

Beacon generation and power management are related activities. Beacon frames are transmitted during the awake periods of STAs operating in PS mode, such that all STAs may process the beacon frames. Furthermore, the source of a beacon frame does not enter the PS state until the end of the next active period, so as to ensure that at least one STA is awake to respond to probe request frames from new STAs scanning for a network.

Thus, the current standard requires that an STA transmitting a beacon frame in an IBSS network to remain awake until the end of the next ATIM window to ensure that any probe request sent by an STA scanning for a network is answered. The STA is kept awake regardless of whether or not the STA has packets to send or receive. Significant power is therefore dissipated by the STA. Thus, there is a need for new schemes that allow the beacon generating STA to enter a doze mode and for probe request messages to be answered by other STAs in awake states.

### SUMMARY

The present invention provides new power-saving techniques for beacon generation in an ad hoc computer network (e.g., IBSS). Techniques according to the present invention are applicable not only to an environment in which all STAs that send out ATIM/ACK frames are kept awake throughout a beacon interval, but are also applicable to an environment in which such STAs can enter doze modes at will. According to one embodiment, the present invention provides an algorithm by which a beacon STA may hand over its responsibility to another STA in an awake state. For a relatively large beacon interval, substantial energy saving could be achieved.

According to one embodiment, to further increase power saving for battery-operated STAs, the present invention distinguishes battery-operated STAs from “always-on” STAs that have a reliable power supply. Not only are the always-on STAs more likely under a priority-based DCF to become a beacon STA, the always-on STAs are also more likely to become a new beacon STA when a beacon station handover happens.

In the detailed description below, various embodiments provide details regarding algorithms used under different setups. These embodiments illustrate beacon handover, awake-list updates, setting the power management field, and sending and processing power management notification messages. According to some embodiments of the present invention, the always-on STAs are given more responsibility to support beacon generation.

The present invention is better understood upon consideration of the detailed description below and the accompanying drawings.

### BRIEF DESCRIPTION OF THE DRAWINGS

FIG. 1 shows the format for a probe request frame.

FIG. 2 shows data fields within a frame control field of a frame.

FIG. 3 shows the format for a probe response frame.

FIG. 4 shows the format for an acknowledge (ACK) frame.

FIG. 5 shows the generic format for a management frame.

FIG. 6 shows fields in the IBSS parameter set of a beacon frame.

FIG. 7 shows the process of beacon frame generation in an IBSS.

FIG. 8 shows the basic operations of power management in an IBSS.

FIG. 9 shows a beacon frame generation procedure in accordance with one embodiment of the present invention.

FIG. 10 shows two ways an STA may send out the notification message, in accordance with one embodiment of the present invention.

FIG. 11 shows a process by which an always-on STA participate in beacon generation, according to one embodiment of the present invention.

FIG. 12 shows the operations of an STA, in accordance with a third embodiment of the present invention.

FIG. 13 illustrates a method to reduce the number of beacon STA handover, in accordance with a fourth embodiment of the present invention.

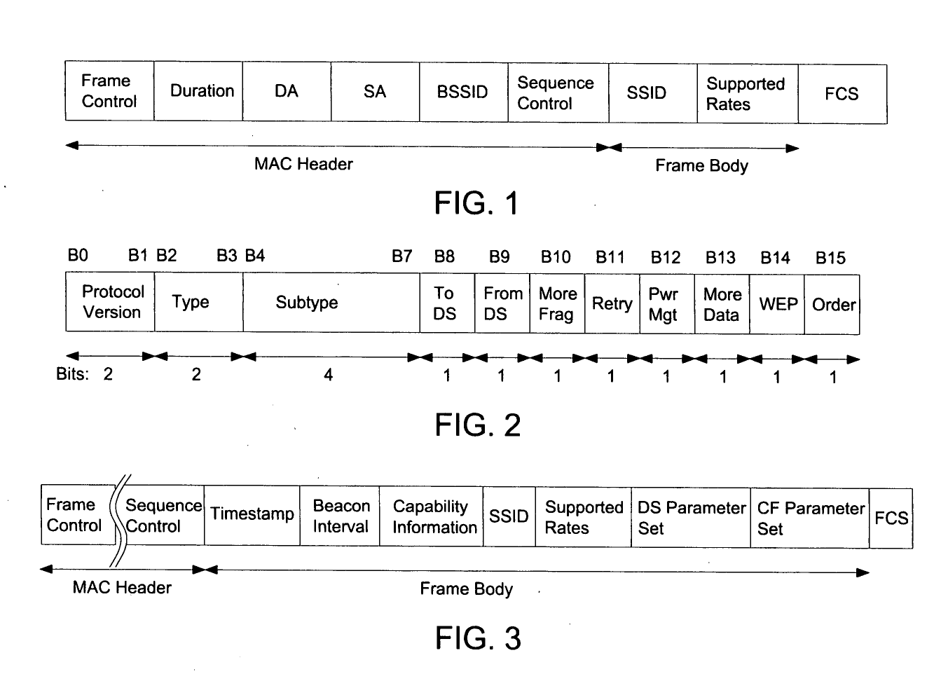

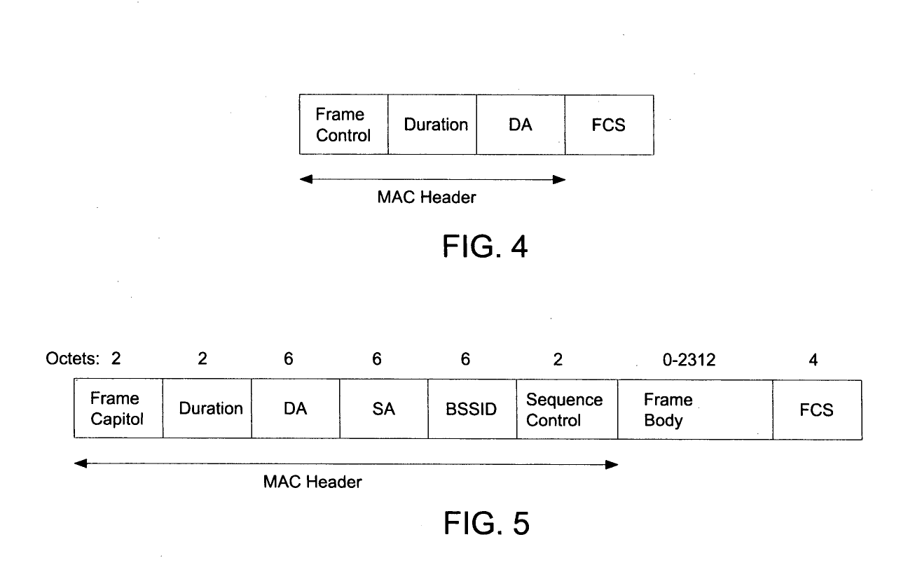

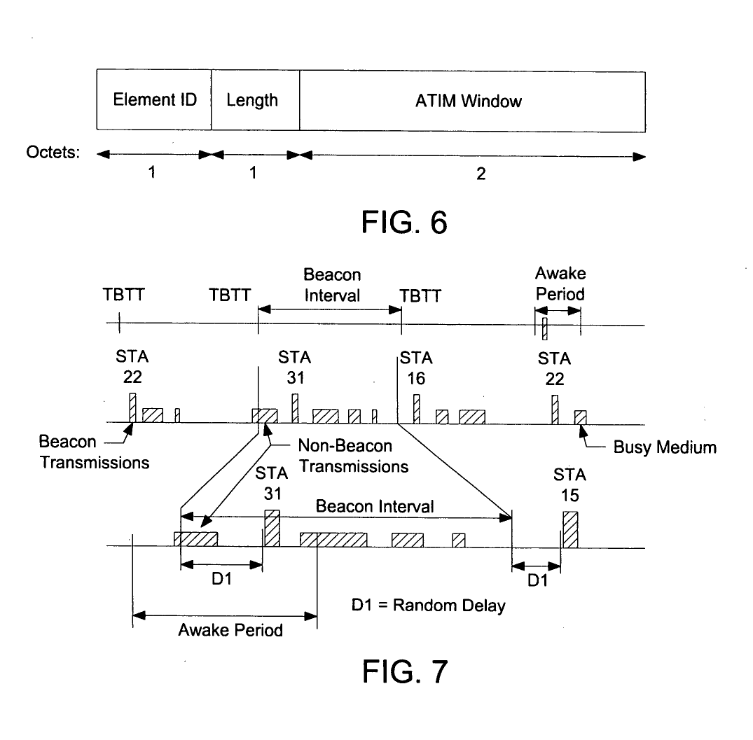

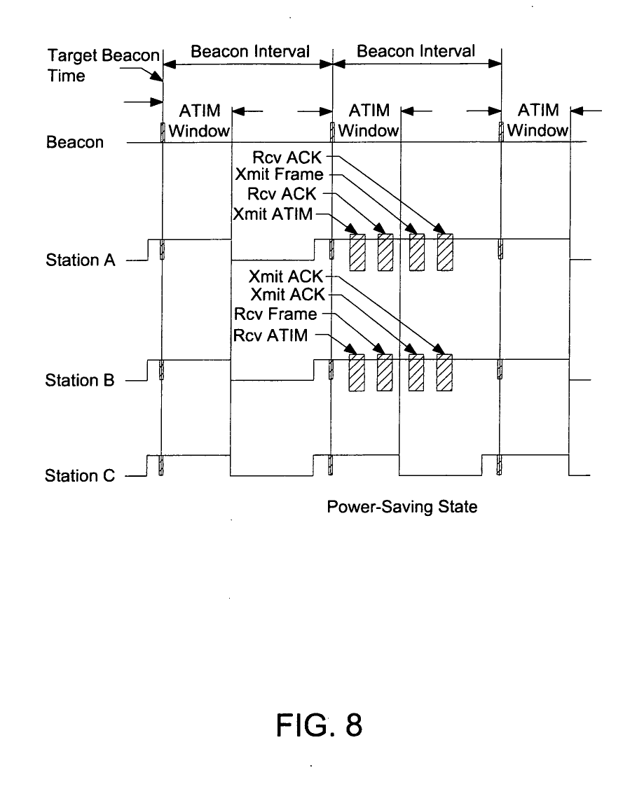

### DETAILED DESCRIPTION OF THE PREFERRED EMBODIMENTS

The present invention optimizes power-saving for beacon-generating STAs.

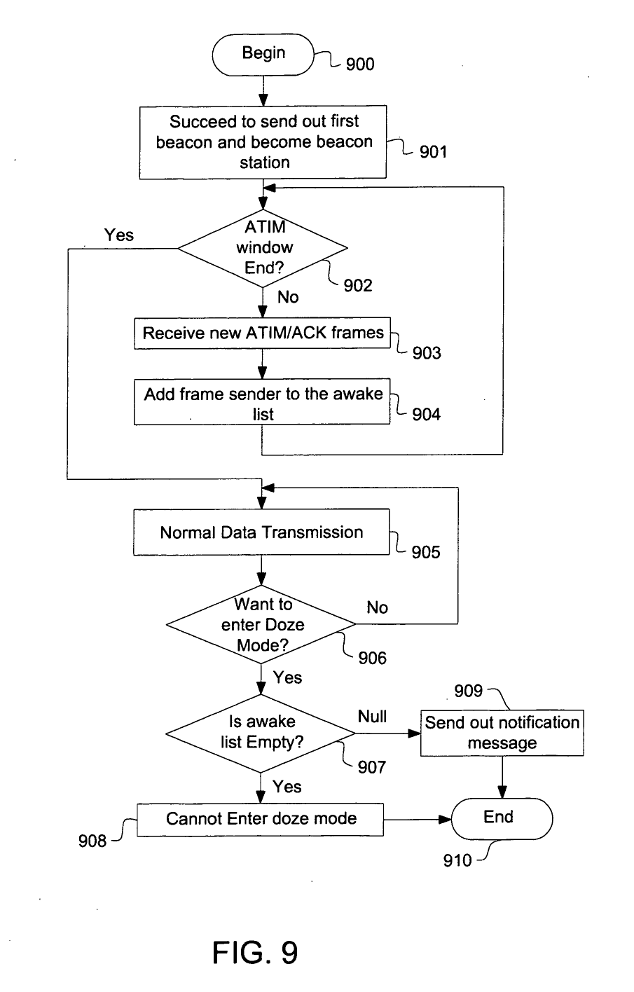

In one embodiment of the present invention, an STA sending out or receiving ATIM messages within an ATIM window remains in the awake state until the end of the next ATIM window, as is the practice under current 802.11 standard. Also, in this embodiment, all STAs operate in power-saving modes (i.e., there are no always-on stations). FIG. 9 shows a beacon frame generation procedure according to this embodiment of the present invention. In this procedure, an STA that stays awake during a beacon interval sets to ‘1’ the power management field in the MAC header in each of its control packets. Otherwise, if the STA may change its power management state from the awake state to a doze state, the power management field is set to 0.

As shown in FIG. 9, after sending out the beacon frame (step 901) with the power management field in the MAC header set to ‘0’ to indicate an intention to go to doze state to save power, the beacon STA operates in a promiscuous mode in the ATIM window of this beacon interval. During the remainder of the ATIM window, the promiscuous mode enables the beacon STA to examine the power management fields in the MAC headers of ATIM or ACK messages from STAs that remain in the awake state during the current beacon interval. From the ATIM or ACK messages, the beacon STA compiles an awake list that includes STAs that are in the awake mode (steps 903, 904). At the end of the ATIM window, normal data traffic is carried out on the wireless network (step 905). After the normal data transmission, if the STA wishes to enter the doze mode (step 906), the STA examines if the awake list is empty (i.e., no ATIM exchanges, step 908). The beacon STA keeps awake in the next beacon interval (step 1011). If the awake list is not empty, a notification message is sent to its neighbors (step 909) to notify the STA's intended change in power management state.

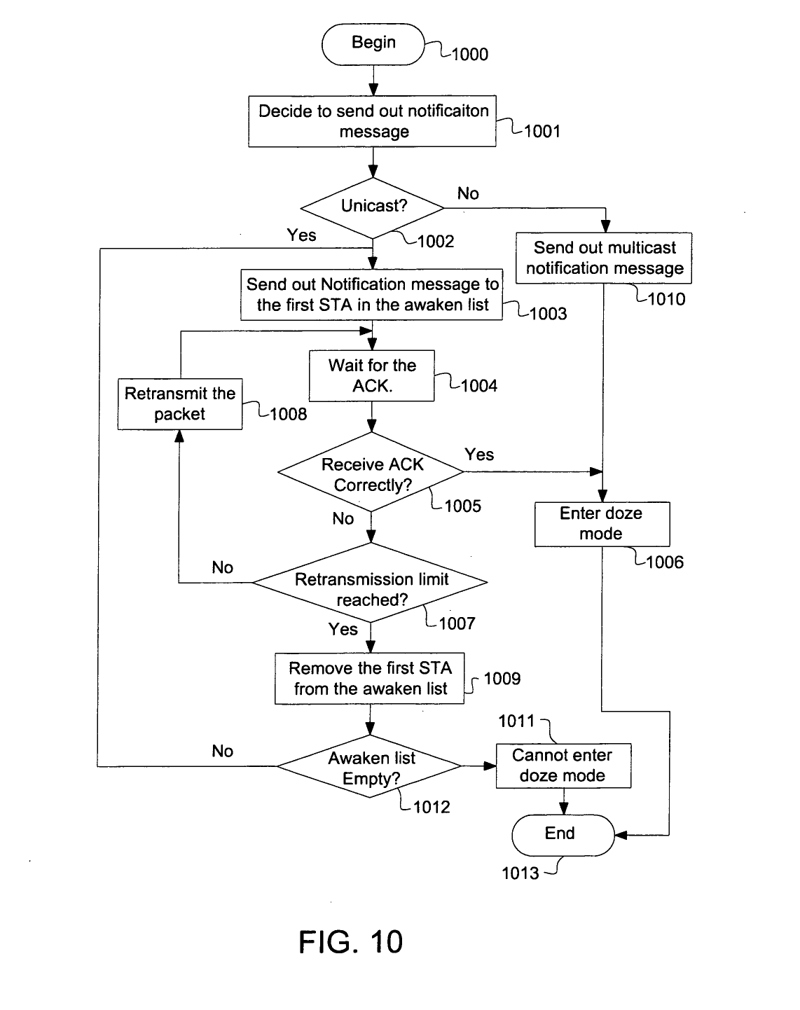

FIG. 10 shows two ways by which an STA may send out the notification message. As shown in FIG. 10, the beacon STA may send out a unicast null data frame (e.g., as type 10, subtype 0100) to the first STA on its awake list which is collects using the promiscuous mode at steps 903 and 904 of FIG. 9 during the ATIM window. An STA receiving the unicast null data frame responds by sending an ACK frame to acknowledge the message, and becomes the next beacon STA. (This next beacon STA responds to probe request messages from this time forward.) If the current beacon STA receives the ACK frame correctly (step 1005), the current beacon STA enters a doze mode (step 1006). Otherwise, the current beacon STA resends the null data frame after the timeout, so long as a pre-determined maximum number of resends is not reached (steps 1007, 1008). If the pre-determined resend limit is reached, the current beacon STA sends a notification message to the next STA on the awake list (step 1009), and repeats steps 1003-1009 until the next beacon STA is found.

Alternatively, as shown in FIG. 10, the current beacon STA may send to all its neighbors a multicast null data frame (step 1010), which is not acknowledged. The current beacon STA may enter a doze mode (step 1006) immediately after sending out the multicast null data frame. All awake stations that receive the multicast null data frame may become the next beacon station by being the first to respond to a subsequent probe request frame. After the first of these STAs responds to a probe request message, thereby becoming the next beacon STA, the remaining STAs abort their attempts to respond to that probe request message.

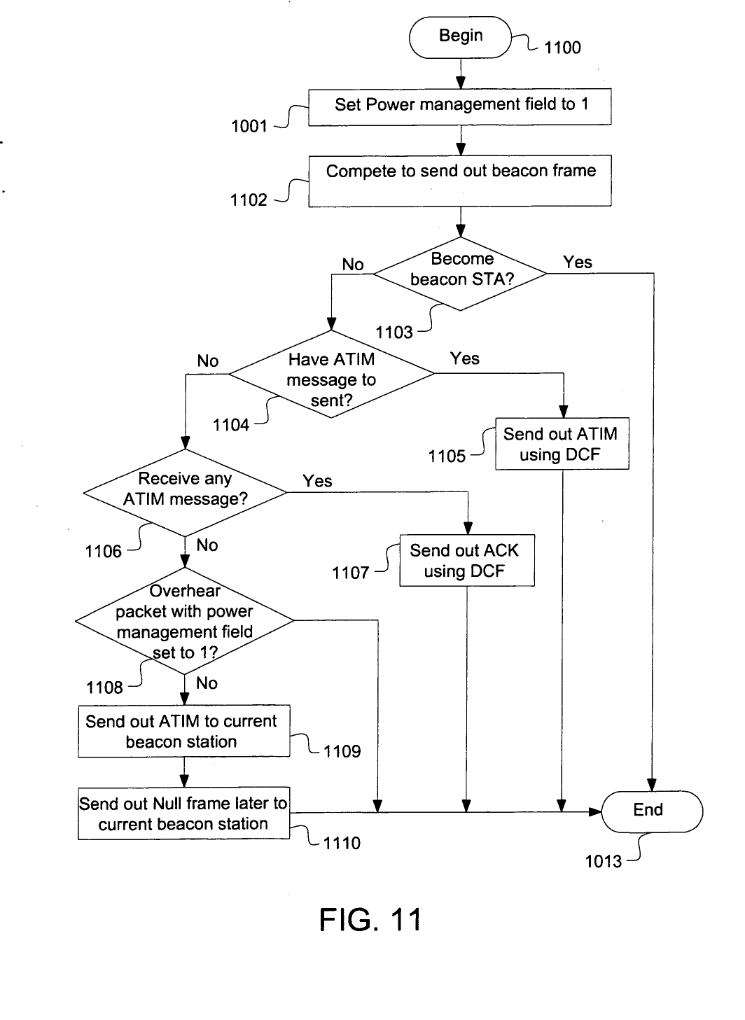

According to another embodiment of the present invention, an STA that sends or receives an ATIM message within the ATIM window would remain in the awake state until the end of the next ATIM window, as is the practice in 802.11 networks. However, in this embodiment, one or more of the STAs operate in an “always-on” state (i.e., does not go into a doze state). An STA operating in an “always-on” state typically has a reliable power supply and, more generally, is more performance oriented. FIG. 11 shows a process by which an always-on STA participates in beacon generation. In this embodiment, each of the always-on STAs may send out a beacon frame at the beginning of the beacon interval, unless it detects a beacon frame by another. Each always-on STA sets the power management field in their control data packets to 1 (step 1101). The STA that sends the first beacon frame in a beacon interval becomes and remains the beacon STA for that beacon interval (step 1103).

After the first beacon frame was sent in a beacon interval, the beacon STA operates in promiscuous mode to listen to the control packets being exchanged. When an always-on station needs to send out an ATIM frame or ACK frame to another STA (steps 1104, 1106), the always-on STA sets the power management field of the ATIM or ACK frame to ‘1’ (step 1105, 1107). When the beacon STA detects the value ‘1’ in the power management field of a control packet, the beacon STA includes the sender STA in its awake list. If the always-on station has no ATIM/ACK exchange of its own (step 1108), the always-on station may send out an ATIM message to the beacon STA with the power management field set to ‘1’, so as to be included in the beacon STA's awake list (step 1109). After the ATIM window expires, the always-on STA sends a null data frame to the beacon STA to complete the announced transmission (step 1110).

Prior to sending out its ATIM frame to the beacon STA at step 1109, if the always-on STA operates in the promiscuous mode and receives an ATIM or ACK frame with the power management field set to ‘1’, the always-on STA need not carry out sending the ATIM frame to the beacon STA at step 1109, as there is already another always-on STA available to respond to subsequent probe request frames.

The beacon STA treats the always-on STAs in the same manner as other STAs in PS mode. Because some always-on stations may remain silent when the awake list is not empty, the beacon STA's awake list does not necessarily include all available STAs. The beacon STA may send out notification messages to STAs on the awake list in the manner shown in FIG. 10 to locate the next beacon STA, if it changes its power management mode.

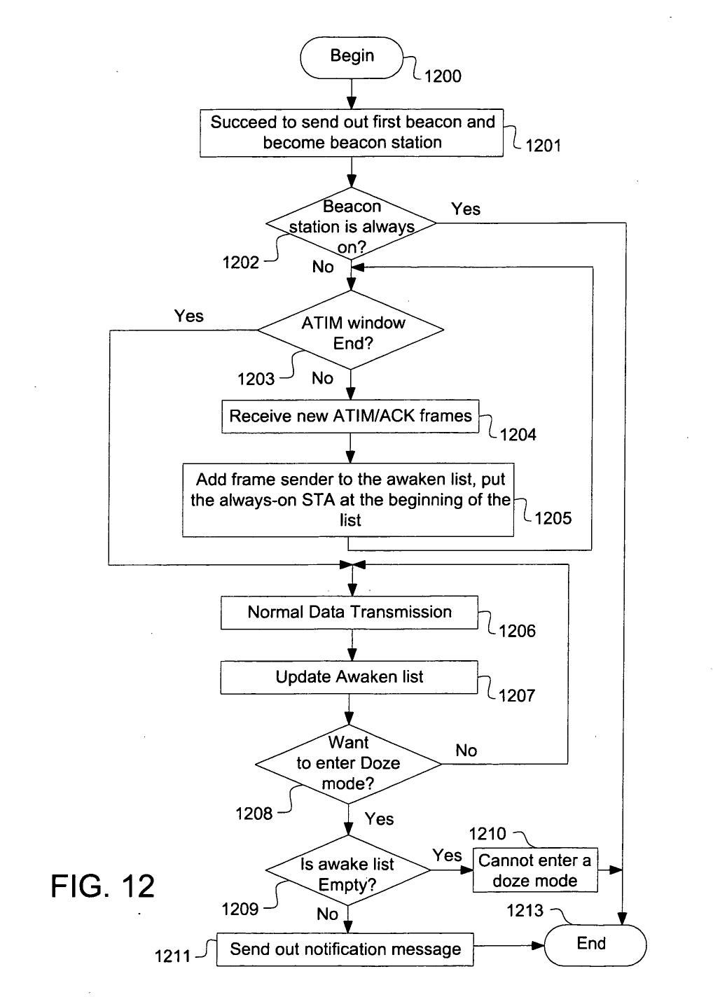

According to a third embodiment of the present invention, STAs sending out or receiving ATIM messages within the ATIM window can change their power management state from “awake” to “doze” after completing the sending or and receiving of all the announced frames. In this embodiment, all stations may operate in PS mode. Because every STA can change its power management state, a beacon STA updates its awake list continuously. At the beginning of each beacon interval, each STA may attempt to be the first to send out a beacon frame, using the normal DCF procedure. The first STA that sends out the beacon frame becomes the beacon STA for that beacon interval. FIG. 12 shows the operations of an STA in this embodiment. The beacon STA may set the power management field in the beacon frame to ‘1’, if it intends to remain in the awake state (step 1202). Otherwise, the power management field is set to ‘0’.

After sending out the beacon frame, if the beacon STA goes into a doze state to save power, after having set the power management field in the beacon frame to ‘0’, the beacon STA operates in the promiscuous mode during the remainder of the ATIM window, so as to compile a list of STAs that send out ATIM or ACK frames (steps 1203-1205). Any of the STAs on the list may be delegated the task of responding to probe request messages when the current beacon STA enters a doze mode. If the beacon STA's awake list is empty (i.e., there are no ATIM exchanges), the beacon STA stays awake for the remainder of the beacon interval (1210). Each STA may operate in the promiscuous mode in the ATIM window to compile a record of those neighbors announcing their awake states.

When sending an ATIM or ACK frame, an STA indicates whether or not it may enter into a doze mode by setting the power management field in a control frame to either a ‘1’ or a ‘0’, as appropriate. Each STA may run its own algorithm to determine when to enter a doze state. One such algorithm is disclosed in copending U.S. patent application (“Copending Application”), Ser. No. ______, entitled “Method and Apparatus for Power Saving in Packet Transmission of 802.11 in ad hoc Mode”, based on U.S. provisional patent application, Ser. No. 60/692,798. The Copending Application is hereby incorporated by reference in its entirety. Within the beacon interval, during the normal data transmission interval, an STA sets its power management field of a data frame to ‘1’ if it remains in the awake state after the current frame exchange. Alternatively, the STA sets the power management field of a data frame to ‘0’, if it enters a doze state after the current frame exchange. To notify STAs that do not operate in the promiscuous mode and do not receive the data frames, an STA going into a doze mode sends out a multicast null data frame with a power management field set to ‘0’. This data frame is not acknowledged. Each STA receiving this null data frame removes the sending STA from its awake list.

Prior to entering a doze mode, the beacon STA first examines its awake list. If the awake list is empty, the beacon STA remains in awake mode. Otherwise, the beacon STA sends out a notification message prior to entering a doze mode. As in the process described in conjunction with FIG. 9, the notification message may be a unicast message or a multicast message.

The beacon station may send out a multicast null data frame with the power management field set to ‘0’. An STA receiving this null frame recognizes from the source address of the multicast data frame that the beacon STA intends to enter a doze mode. In response, each recipient prepares to be the first to respond to the next probe request frame. While this scheme is simple, it is possible that there is not an STA to respond to the next probe request frame, as a multicast null data frame is not acknowledged.

Alternatively, the beacon STA may send a unicast null data frame to announce its power management change to one of the STAs in the awake list and wait for a responsive ACK frame from the recipient. Preference may be given to sending the notification message to always-on STAs first to reduce future beacon station handovers. If no ACK frame is received after a pre-determined time period, the beacon STA may retransmit that null data frame to the same STA again, or to another STA on the awake list until every STA on the list has been unsuccessfully contacted; in that event, the beacon STA remains in the awake state for the remainder of the beacon interval. Otherwise, the STA that returns an ACK frame becomes the next beacon STA, and the current STA may enter a doze state.

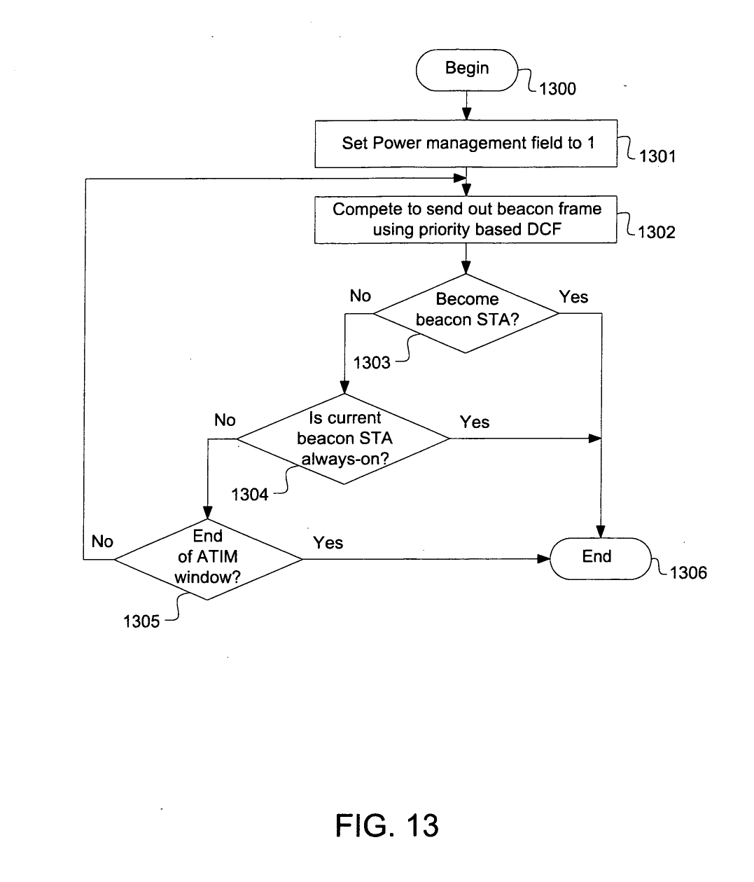

According to a fourth embodiment of the present invention, STAs sending out or receiving ATIM frame within the ATIM window can change their power management state from awake to doze after completing sending and receiving all frames. In this fourth embodiment, some STAs may operate in the always-on state. Such always-on STAs may have a reliable power supply or have other reasons to remain in the awake state, and may operate in the manner explained above for always-on STAs. This fourth embodiment seeks to reduce the number of beacon STA handovers. FIG. 13 illustrates a method to reduce the number of beacon STA handovers.

As shown in FIG. 13, the possibility that an always-on STA becoming the beacon station is enhanced by using a priority-based DCF scheme to determine the beacon STA (step 1302). When an always-on STA becomes a beacon STA, beacon STA handover does not occur for the remainder of the beacon interval. The priority-based DCF gives preference to an always-on STA, such that the always-on STA is more likely to be the first to send out a beacon frame and thus more likely to become the beacon STA (1303). Existing priority-based DCF variations are known to those skilled in the art. Some priority-based DCF variations include different contention window sizes or different back-off parameter values.

Alternatively, under this fourth embodiment, an always-on STA may have an additional chance to send out a beacon frame in the current beacon interval, if and when the beacon STA determined at step 1302 decides to enter a doze state. When an always-on STA receives a beacon frame, it examines the power management field of the beacon frame. If the power management field is set to ‘1’, it indicates that the current beacon STA intends to remain in the awake state. No further action is taken by the recipient STA. However, if the power management field is found set to ‘0’, the always-on STA may then send a beacon frame with the power management field set to ‘1’ to indicate that it has become the next beacon STA.

The detailed description above is provided to illustrate the specific embodiments of the present invention and is not intended to be limiting. Numerous modifications and variations within the scope of the present invention are possible. The scope of the present invention is set forth in the following claims.

We claim:

1. A method to allow a beacon station in an ad hoc wireless network to enter a power saving state, comprising:
during a beacon interval, sending from the beacon station a control message that indicates that the beacon station entering a power saving state; and
going into the power-saving state prior to the expiration of the beacon interval.

2. A method as in claim 1, wherein the control message is unicast.

3. A method as in claim 2, wherein the beacon station goes into the power-saving state only upon receiving an acknowledgement frame from the recipient of the control message.

4. A method as in claim 2, wherein the recipient of the unicast control message is determined from an awake list maintained by the beacon station.

5. A method as in claim 4, wherein the beacon station goes into the power-saving state only upon receiving an acknowledgement frame from a recipient of the control message, and wherein the beacon station sends the control message to multiple recipient stations on the awake list until an acknowledgement is received from one of the recipient stations.

6. A method as in claim 4, wherein the beacon station compiles the awake list by examining under promiscuous mode control packets sent during a predetermined window.

7. A method as in claim 1, wherein the control message is multicast.

8. A method as in claim 7 wherein, upon receiving the control message, a plurality of the stations in the ad hoc wireless network prepare to respond to a probe request frame.

9. A method as in claim 8 wherein the first one of the stations responding to the probe request frame becomes a beacon station.

10. A method as in claim 8, wherein one of the stations in the ad hoc wireless network is an always-on station.

11. A method as in claim 1, wherein the beacon station was the first station to send out a beacon frame during the beacon interval.

12. A method as in claim 1, wherein the beacon station is determined using a distributed coordination function.

13. A method as in claim 12, wherein the distributed coordination function gives priority to always-on stations.

14. A method as in claim 1, wherein the beacon station is an always-on beacon station.

15. A method as in claim 1, wherein the beacon station maintains an awake list by listening in a promiscuous mode to selected control messages sent during a predetermined interval.

16. A method as in claim 1, wherein a plurality of stations in the ad hoc wireless network each maintain an awake list by listening in a promiscuous mode to selected control messages sent during a predetermined interval.

17. A method as in claim 16, wherein the selected control messages each include in a header a power management field by which the sender of the selected control message indicates a transition of its power state.

18. A method as in claim 17, wherein an always-on station sets the power management field to a predetermined value.

19. A method as in claim 16 wherein, upon detecting an empty awake list at the expiration of predetermined interval, an always-on station sends the beacon station a control message to indicate availability.

20. A method as in claim 1, wherein selected control messages are sent during a predetermined interval each including in a header a power management field by which the sender of the selected control message indicates a transition of its power state

21. A method as in claim 20, wherein one of the selected control messages is a beacon frame.

22. A method as in claim 20, wherein one of the selected control messages is an ATIM frame.

23. A method as in claim 20, wherein one of the selected control messages is an ACK frame.

24. A method as in claim 1, wherein the control message comprises a power management field, wherein the value of the power management field indicates that the beacon station intends to enter the power-saving state.
